(19) United States
(12) Patent Application Publication
(10) Pub. No.: US 2008/0030920 A1
(43) Pub. Date: Feb. 7, 2008

(54) METHOD OF OPERATING AN ELECTROSTATIC AIR CLEANING DEVICE

(75) Inventors: Igor A. Krichtafovitch, Kirkland, WA (US); Vladimir L. Gorobets, Redmond, WA (US)

Correspondence Address: FULBRIGHT & JAWORSKI;MARKET SQUARE, 801 PENNSLYVANIA, N.W., WASHINGTON, DC, 200042604, US

(73) Assignee: Kronos Advanced Technologies, Inc., Belmont, MA (US)

(21) Appl. No.: 11/612,270

(22) Filed: Dec. 18, 2006

Related U.S. Application Data
(63) Continuation of application No. 10/752,530, filed on Jan. 8, 2004, now Pat. No. 7,150,780.

(51) Int. Cl. B03C 3/08; B03C 3/12

(52) U.S. Cl. 361/233

(57) ABSTRACT

A method of operating an electrostatic fluid accelerating device includes applying a voltage to a plurality of corona electrodes and a plurality of complementary electrodes so as to generate a corona discharge to thereby propel an intervening fluid in a desired fluid flow direction. A direction of the fluid in a region adjacent a protuberant portion of each of said complementary electrodes is altered to create a turbulent fluid flow in the regions adjacent said protuberant portion. The fluid flow is propelled away from repelling electrodes and toward the complementary electrodes, each of the repelling electrodes having a substantially planar portion and at least one protuberant portion extending outwardly in a lateral direction substantially perpendicular to the desired fluid-flow direction.

### RELATED APPLICATIONS

The instant application is a continuation of U.S. patent application Ser. No. 10/752,530 filed Jan. 8, 2004, now U.S. Pat. No. 7,150,780, and is related to U.S. patent application Ser. No. 09/419,720 filed Oct. 14, 1999 and entitled Electrostatic Fluid Accelerator, now U.S. Pat. No. 6,504,308; U.S. patent application Ser. No. 10/187,983 filed Jul. 3, 2002 and entitled Spark Management Method And Device; now, U.S. Pat. No. 6,937,455; U.S. patent application Ser. No. 10/175,947 filed Jun. 21, 2002 and entitled Method Of And Apparatus For Electrostatic Fluid Acceleration Control Of A Fluid Flow, now U.S. Pat. No. 6,664,741, and the Continuation-In-Part thereof, U.S. patent application Ser. No. 10/735,302 filed Dec. 15, 2003 of the same title, now U.S. Pat. No. 6,963,479; U.S. patent application Ser. No. 10/188,069 filed Jul. 3, 2002 and entitled Electrostatic Fluid Accelerator For And A Method Of Controlling Fluid Flow, now U.S. Pat. No. 6,727,657; U.S. patent application Ser. No. 10/352,193 filed Jan. 28, 2003 and entitled An Electrostatic Fluid Accelerator For Controlling Fluid Flow, now U.S. Pat. No. 6,919,698; U.S. patent application Ser. No. 10/295,869 filed Nov. 18, 2002 and entitled Electrostatic Fluid Accelerator, now U.S. Pat. No. 6,888,314; U.S. patent application Ser. No. 10/724,707 filed Dec. 2, 2003 and entitled Corona Discharge Electrode And Method Of Operating The Same, U.S. Pat. No. 7,157,704, each of which is incorporated herein in its entirety by reference.

### BACKGROUND OF THE INVENTION

1. Field of the Invention

The invention relates to a device for electrostatic air cleaning. The device is based on the corona discharge and ions acceleration along with dust particles charging and collecting them on the oppositely charged electrodes.

2. Description of the Related Art

A number of patents (see, e.g. U.S. Pat. Nos. 4,689,056 and 5,055,118) describe electrostatic air cleaning devices that including (i) ion and resultant air acceleration generated by a corona discharge method and device coupled with (ii) charging and collection of airborne particulates, such as dust. These corona discharge devices apply a high voltage potential between corona (discharge) electrodes and collecting (or accelerating) electrodes to create a high intensity electric field and generate a corona discharge in a vicinity of the corona electrodes. Collisions between the ions generated by the corona and surrounding air molecules transfer the momentum of the ions to the air thereby inducing a corresponding movement of the air to achieve an overall movement in a desired air flow direction.

U.S. Pat. No. 4,689,056 describes the air cleaner of the ionic wind type including corona electrodes constituting a dust collecting arrangement having the collecting electrodes and repelling electrodes alternately arranged downstream of said corona electrode. A high voltage (e.g., 10-25 kV) is supplied by a power source between the corona electrodes and the collecting electrodes to generate an ionic wind in a direction from the corona electrodes to the collecting electrode. As particulates present in the air pass through the corona discharge, a charge corresponding to the polarity of the corona electrodes is accumulated on these particles such that they are attracted to and accumulate on the oppositely-charged collecting electrodes. Charging and collecting of the particles effectively separates-out particulates such as dust from fluids such as air as it passes through the downstream array of collecting electrodes. Typically, the corona electrodes are supplied with a high negative or positive electric potential while the collecting electrodes are maintained at a ground potential (i.e., positive or negative with respect to the corona electrodes) and the repelling electrodes are maintained at a different potential with respect to the collecting electrodes, e.g., an intermediate voltage level. A similar arrangement is described in U.S. Pat. No. 5,055,118.

These and similar arrangements are capable of simultaneous air movement and dust collection. However, such electrostatic air cleaners have a comparatively low dust collecting efficiency that ranges between 25-90% removal of dust from the air (i.e., “cleaning efficiency”). In contrast, modern technology often requires a higher level of cleaning efficiency, typically in the vicinity of 99.97% for the removal of dust particles with diameter of 0.3 Φm and larger. Therefore state-of-the-art electrostatic air cleaners can not compete with HEPA (high efficiency particulate air) filtration-type filters that, according to DOE-STD-3020-97, must meet such cleaning efficiency.

Accordingly, a need exists for an electrostatic fluid precipitator and, more particularly, an air cleaning device that is efficient at the removal of particulates present in the air.

### SUMMARY OF THE INVENTION

One cause for the relatively poor collecting efficiency of electrostatic devices is a general failure to consider movement of the charged particulates and their trajectory or path being charged in the area of the corona discharge. Thus, a dust particle receives some charge as it passes near the corona electrode. The now charged particle is propelled from the corona electrodes toward and between the collecting and repelling electrodes. The electric potential difference between these electrodes plates creates a strong electric field that pushes the charged particles toward the collecting electrode. The charged dust particles then settle and remain on the collecting electrode plate.

A charged particle is attracted to the collecting electrode with a force which is proportional to the electric field strength between the collecting and repelling electrodes' plates:
\vec{F}=q\vec{E}
As expressed by this equation, the magnitude of this attractive force is proportional to the electric field and therefore to the potential difference between the collecting and repelling plates and inversely proportional to the distance between these plates. However, a maximum electric field potential difference is limited by the air electrical dielectric strength, i.e., the breakdown voltage of the fluid whereupon arcing will occur. If the potential difference exceeds some threshold level then an electrical breakdown of the dielectric occurs, resulting in extinguishment of the field and interruption of the air cleaning processing/operations. The most likely region wherein the electrical breakdown might occur is in the vicinity of the edges of the plates where the electric field gradient is greatest such that the electric field generated reaches a maximum value in such regions.

Another factor limiting particulate removal (e.g., air cleaning) efficiency is caused by the existence of a laminar air flow in-between the collecting and repelling electrodes, this type of flow limiting the speed of charged particle movement toward the plates of the collecting electrodes.

Still another factor leading to cleaning inefficiency is the tendency of particulates to dislodge and disperse after initially settling on the collecting electrodes. Once the particles come into contact with the collecting electrode, their charges dissipate so that there is no longer any electrostatic attractive force causing the particles to adhere to the electrode. Absent this electrostatic adhesion, the surrounding airflow tends to dislodge the particles, returning them to the air (or other fluid being transported) as the air flow through and transits the electrode array.

Embodiments of the invention address several deficiencies in the prior art such as: poor collecting ability, low electric field strength, charged particles trajectory and resettling of particles back onto the collecting electrodes. According to one embodiment, the collecting and repelling electrodes have a profile and overall shape that causes additional air movement to be generated in a direction toward the collecting electrodes. This diversion of the air flow is achieved by altering the profile from the typical flat, planar shape and profile with the insertion or incorporation of bulges or ridges.

Note that, as used herein and unless otherwise specified or apparent from context of usage, the terms “bulge”, “projection”, “protuberance”, “protrusion” and “ridge” include extensions beyond a normal line or surface defined by a major surface of a structure. Thus, in the present case, these terms include, but are not limited to, structures that are either (i) contiguous sheet-like structures of substantially uniform thickness formed to include raised portions that are not coplanar with, and extend beyond, a predominant plane of the sheet such as that defined by a major surface of the sheet (e.g., a “skeletonized” structure), and (ii) compound or composite structures of varying thickness including (a) a sheet-like planar portion of substantially uniform thickness defining a predominant plane and (b) one or more “thicker” portions extending outward from the predominant plane (including structures formed integral with and/or on an underlying substrate such as lateral extensions of the planar portion).

According to one embodiment, the bulges or ridges run along a width of the electrodes, substantially transverse (i.e. orthogonal) to the overall airflow direction through the apparatus. The bulges protrude outwardly along a height direction of the electrodes. The bulges may include sheet-like material formed into a ridge or bulge and/or portions of increased electrode thickness. According to an embodiment of the invention, a leading edge of the bulge has a rounded, gradually increasing or sloped profile to minimize and/or avoid disturbance of the airflow (e.g., maintain and/or encourage a laminar flow), while a trailing portion or edge of the bulge disrupts airflow, encouraging airflow separation from the body of the electrode and inducing and/or generating a turbulent flow and/or vortices. The bulges may further create a downstream region of reduced air velocity and/or redirect airflow to enhance removal of dust and other particulates from and collection on the collecting electrodes and further retention thereof. The bulges are preferably located at the ends or edges of the electrodes to prevent a sharp increase of the electric field. Bulges may also be provided along central portions of the electrodes spaced apart from the leading edge.

In general, the bulges are shaped to provide a geometry that creates “traps” for particles. These traps should create minimum resistance for the primary airflow and, at the same time, a relatively low velocity zone on a planar portion of the collecting electrode immediately after (i.e., at a trailing edge or “downwind” of) the bulges.

Embodiments of the present invention provide an innovative solution to enhancing the air cleaning ability and efficiency of electrostatic fluid (including air) purifier apparatus and systems. The rounded bulges at the ends of the electrodes decrease the electric field around and in the vicinity of these edges while maintaining an electric potential difference and/or gradient between these electrodes at a maximum operational level without generating sparking or arcing. The bulges are also effective to make air movement turbulent. Contrary to prior teachings, a gentle but turbulent movement increases a time period during which a particular charged particle is present between the collecting and repelling electrodes. Increasing this time period enhances the probability that the particle will be trapped by and collect on the collecting electrodes. In particular, extending the time required for a charged particle to transit a region between the collecting electrodes (and repelling electrodes, if present) enhances the probability that the particle will move in sufficiently close proximity to be captured by the collecting electrodes.

The “traps” behind the bulges minimize air movement behind (i.e., immediately “downwind” of) the bulges to a substantially zero velocity and, in some situations, results in a reversal of airflow direction in a region of the trap. The reduced and/or reverse air velocity in the regions behind the traps results in those particles that settle in the trap not being disturbed by the primary or dominant airflow (i.e., the main airstream). Minimizing disturbance results in the particles being more likely to lodge in the trap area for some period of time until intentionally removed by an appropriate cleaning process.

According to one embodiment of the invention, a method of operating an electrostatic fluid accelerating device includes applying a voltage to a plurality of corona electrodes and a plurality of complementary electrodes so as to generate a corona discharge to thereby propel an intervening fluid in a desired fluid flow direction. A direction of the fluid in a region adjacent a protuberant portion of each of said complementary electrodes is altered to create a turbulent fluid flow in the regions adjacent said protuberant portion. The fluid flow is propelled away from repelling electrodes and toward the complementary electrodes, each of the repelling electrodes having a substantially planar portion and at least one protuberant portion extending outwardly in a lateral direction substantially perpendicular to the desired fluid-flow direction.

According to another embodiment of the invention, a method of operating an electrostatic air cleaning device includes applying a high voltage to (i) a plurality of corona and (ii) collecting electrodes, the corona electrodes each having respective ionizing edges and of the collecting electrode having a substantially planar portion and a raised trap portion formed on a midsection of the collecting electrode and extending outwardly above a height of the substantially planar portion for a distance greater than a nominal thickness of the planar portion. A repelling electrode is positioned intermediate adjacent pairs of the collecting electrodes. According to a feature of the invention, one or all of the collecting electrodes may include a raised leading portion formed on a leading edge of the collecting electrodes.

Additional objects, advantages and novel features of the invention will be set forth in part in the description which follows, and in part will become apparent to those skilled in the art upon examination of the following and the accompanying drawings or may be learned by practice of the invention. The objects and advantages of the invention may be realized and attained by means of the instrumentalities and combinations particularly pointed out in the appended claims.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a schematic drawing in cross-section of an array of corona, repelling and collecting electrodes forming part of an electrostatic air cleaning the previous art;

FIG. 2 is a schematic drawing in cross-section of an array of electrodes in which the collecting electrodes have a cylindrical bulge portion formed on a leading edge according to an embodiment of the present invention;

FIG. 2A is a perspective view of the electrode arrangement according to FIG. 2;

FIG. 2B is a schematic drawing in cross-section of an array of electrodes in which the collecting electrodes have a transverse tubular bulge portion formed on a leading edge according to an alternate embodiment of the invention;

FIG. 2C is a schematic drawing in cross-section of an alternate structure of a collecting electrode with a partially open tubular leading edge;

FIG. 3 is a schematic drawing in cross-section of an array of electrodes in which the collecting electrodes have a semi-cylindrical bulge portion formed on a leading edge according to another embodiment of the present invention;

FIG. 3A is a detailed view of the leading edge of the collecting electrode depicted in FIG. 3;

FIG. 3B is a schematic drawing in cross-section of an array of electrodes in which the collecting electrodes have a flattened tubular portion formed on a leading edge according to another embodiment of the invention;

FIG. 3C is a detailed view of the leading edge of the collecting electrode depicted in FIG. 3B;

FIG. 3D is a detailed view of an alternate structure for a leading edge of a collecting electrode;

FIG. 4 is a schematic drawing in cross-section of an array of electrodes wherein the collecting electrodes have both a semi-cylindrical bulge portion formed on a leading edge and a wedge-shaped symmetric ramp portion formed along a central portion of the electrodes according to an embodiment of the present invention;

FIG. 4A is a detailed view of the wedge-shaped ramp portion of the collecting electrodes depicted in FIG. 4;

FIG. 4B is a schematic drawing in cross-section of an array of electrodes in which the collecting electrodes have an initial semi-cylindrical bulge, a trailing, plate-like portion of the electrode having a constant thickness formed into a number of ramped and planar portions;

FIG. 4C is a detailed perspective drawing of the collecting electrode of FIG. 4B;

FIG. 4D is a schematic drawing in cross-section of an alternate “skeletonized” collecting electrode applicable to the configuration of FIG. 4B;

FIG. 5 is a schematic drawing of an array of electrodes including the collecting electrodes of FIG. 4 with intervening repelling electrodes having cylindrical bulges formed on both the leading and trailing edges thereof according to another embodiment of the present invention;

FIG. 5A is a schematic drawing of an array of electrodes including the collecting electrodes of FIG. 4C with intervening repelling electrodes having cylindrical bulges as in FIG. 5 according to another embodiment of the present invention;

FIG. 5B is a cross-sectional diagram of alternate repelling electrode structures;

FIG. 6 is a schematic drawing of an electrode array structure similar to that of FIG. 5 wherein a void is formed in a midsection of each of the repelling electrodes; and

FIG. 7 is a photograph of a stepped electrode structure present along a leading edge of a collecting electrode as diagrammatically depicted in FIG. 2.

### DESCRIPTION OF THE PREFERRED EMBODIMENTS

The ensuing description provides exemplary embodiments only, and is not intended to limit the scope, applicability, or configuration of the invention. Rather, the ensuing description of the exemplary embodiments will provide those skilled in the art with an enabling description for implementing an example embodiment of the invention. It should be understood that various changes may be made in the function and arrangement of elements without departing from the spirit and scope of the invention.

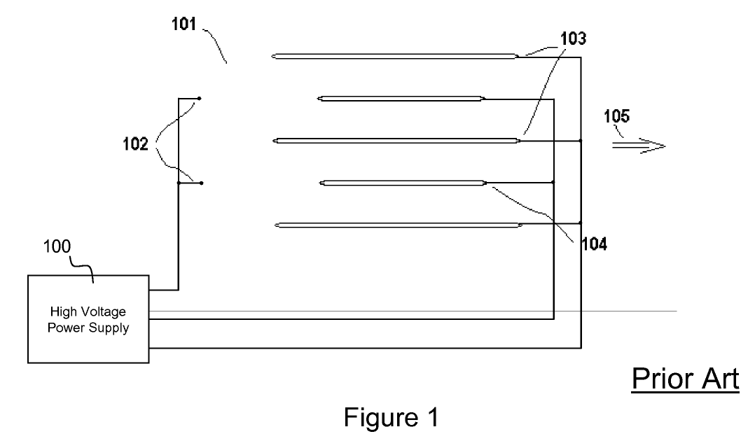

FIG. 1 is a schematic drawing of an array of electrodes that are part of an electrostatic air cleaning device according to the prior art. As shown, an electrostatic air cleaning device includes a high voltage power supply 100 connected to an array of electrodes 101 through which a fluid, such as air, is propelled by the action of the electrostatic fields generated by the electrodes, i.e., the corona discharge created by corona electrodes 102 accelerating air toward oppositely charged complementary electrodes such as collecting electrodes 103. The electrodes are connected to a suitable source of a high voltage (e.g., high voltage power supply 100), in the 10 kV to 25 kV range for typical spacing of the electrodes.

The array of electrodes includes three groups: (i) a subarray of laterally spaced, wire-like corona electrodes 102 (two are shown) which array is longitudinally spaced from (ii) a subarray of laterally spaced, plate-like collecting electrodes 103 (three are shown) while (iii) a subarray of plate-like repelling electrodes 104 (two are shown) are located in-between of and laterally dispersed between collecting electrodes 103. A high voltage power supply (not shown) provides the electrical potential difference between corona electrodes 102 and collecting electrodes 103 so that a corona discharge is generated around corona electrodes 102. As a result, corona electrodes 102 generate ions that are accelerated toward collecting electrodes 103 thus causing the ambient air to move in an overall or predominant desired direction indicated by arrow 105. When air having entrained therein various types of particulates, such as dust (i.e., “dirty air”) enters the arrays from a device inlet portion (i.e., from the left as shown in FIG. 1 so as to initially encounter corona electrodes 102) dust particles are charged by ions emitted by corona electrodes 102. The now charged dust particles enter the passage between collecting electrodes 103 and the repelling electrodes 104. Repelling electrodes 104 are connected to a suitable power source so that they are maintained at a different electrical potential than are collecting electrodes 103, for example, a voltage intermediate or halfway between corona electrodes 102 and collecting electrodes 103. The difference in potential causes the associated electric field generated between these electrodes to accelerate the charged dust particles away from repelling electrodes 104 and toward collecting electrodes 103. However, the resultant movement toward collecting electrodes 103 occurs simultaneously with the overall or dominant air movement toward the outlet or exhaust portion of the device at the right of the drawing as depicted in FIG. 1. This resultant overall motion being predominantly toward the outlet limits the opportunity for particles to reach the surface of collecting electrodes 103 prior to exiting electrode array 101. Thus, only a limited number of particles will be acted upon to closely approach, contact and settle onto the surface of collecting electrodes 103 and thereby be removed from the passing air. This prior art arrangement therefore is incapable of operating with an air cleaning efficiency much in excess of 70-80%, i.e. 20-30% of all dust transits the device without being removed, escapes the device and reenter into the atmosphere.

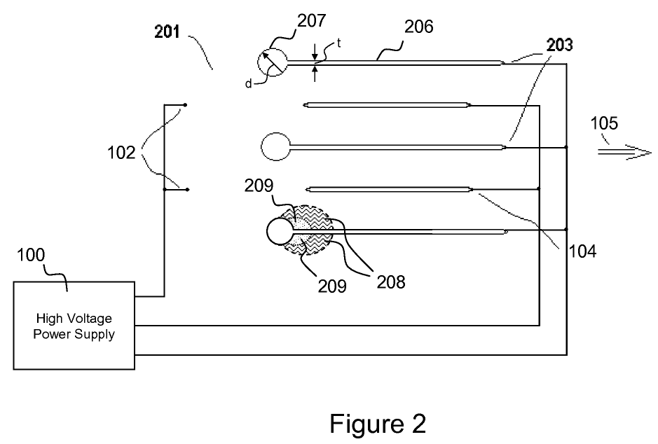

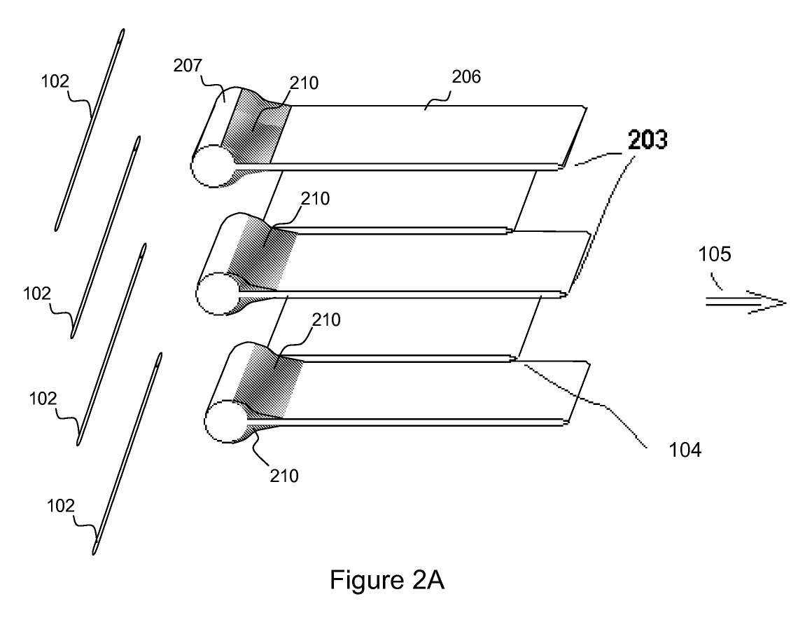

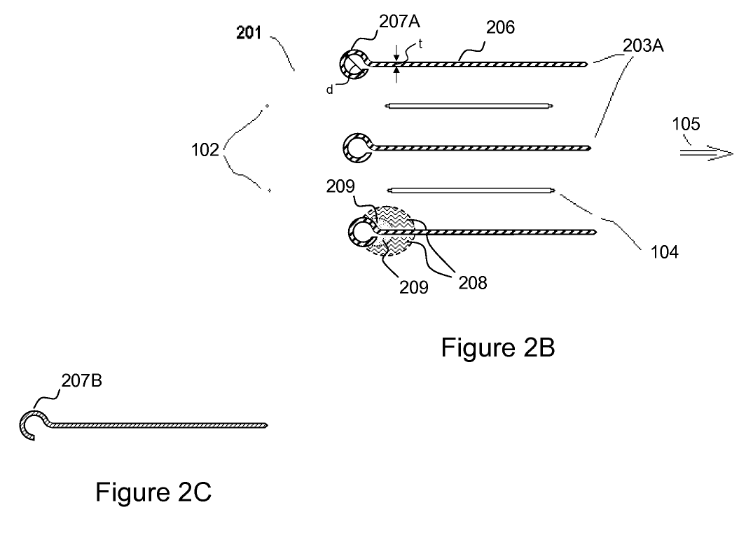

FIG. 2 shows an embodiment of the present invention wherein the geometry of the collecting electrodes is modified to redirect airflow in a manner enhancing collection and retention of particulates on and by the collecting electrodes. As shown, an electrostatic air cleaning device include an array of electrodes 201 including the same grouping of electrodes as explained in connection with FIG. 1, i.e. wire-like corona electrodes 102, collecting electrodes 203 and repelling electrodes 204. Collecting electrodes 203 are substantially planar, i.e., “plate-like” electrodes with a substantially planar portion 206 but having cylinder-shaped bulges 207 at their leading edges, i.e., the portion of the collecting electrodes nearest corona electrodes 102 is in the form of a cylindrical solid. A nominal diameter d of bulges 207 is greater than the thickness t of planar portion 206 and, more preferably, is at least two or three times that of t. For example, if planar portion 206 has a thickness t=1 mm, then d>1 mm and preferably d>2 mm, and even more preferably d>3 mm.

Corona electrodes 102, collecting electrodes 203 and repelling electrodes 204 are connected to an appropriate source of high voltages such as high voltage power supply 100 (FIG. 1). Corona electrodes 102 are connected so as to be maintained at a potential difference of 10-25 kV with reference to collecting electrodes 203 with repelling electrodes 204 maintained at some intermediate potential. Note that the electrical potential difference between the electrodes is important to device operation rather than absolute potentials. For example, any of the sets of electrodes may be maintained near or at some arbitrary ground reference potential as may be desirable or preferred for any number of reasons including, for example, ease of power distribution, safety, protection from inadvertent contact with other structures and/or users, minimizing particular hazards associated with particular structures, etc. The type of power applied may also vary such as to include some pulsating or alternating current and/or voltage component and/or relationship between such components and a constant or d.c. component of the applied power as described in one or more of the previously referenced patent applications and/or as may be described by the prior art. Still other mechanisms may be included for controlling operation of the device and performing other functions such as, for example, applying a heating current to the corona electrodes to rejuvenate the material of the electrodes by removing oxidation and/or contaminants formed and/or collecting thereon, as described in the cited related patent applications.

The arrangement of FIG. 2 is further depicted in the perspective view shown in FIG. 2A, although the width of collecting electrodes 203 and repelling electrodes 204 in the transverse direction (i.e., into the paper) is abbreviated for simplicity of illustration. As depicted therein, particulates 210 such as dust are attracted to and come to rest behind or downwind of cylinder-shaped bulge 207 in the general region of quiet zone 209 (FIG. 2).

Referring again to FIG. 2, the geometry of collecting electrodes 203 results in an enhanced dust collection capability and efficiency of dust removal. The enhanced efficiency is due at least in part to the altered airflow becomes turbulent in a region 208 behind cylinder-shaped bulges 207 and enters into a quiet zone 209 where charged particles settle down onto the surfaces of collecting electrodes 203 (FIG. 2A). For example, while planar portion 206 may exhibit a relatively high Reynolds number Re₁ (e.g., Re₁ ∃100, preferably Re₁ ∃1000), a relatively low Reynolds number Re₂ in turbulent region 208 and/or quiet zone (e.g., Re₂<100 and, preferably Re₂ # 10 and more preferably Re₂ # 5). Secondly, settled particles have greater chances to remain in the quiet zone and do not re-enter into the air. Thirdly, the bulges force air to move in a more complicated trajectory and, therefore, are in the vicinity and/or on contact with a “collecting zone” portion of collecting electrode 203 (e.g., quiet zone 209 and/or region 208) for an extended period of time. Individually and taken together these improvements dramatically increase the collecting efficiency of the device.

FIG. 2B depicts and alternate construction, collecting electrodes 203A having a skeletonized construction comprising a contiguous sheet of material (e.g., an appropriate metal, metal alloy, layered structure, etc.) of substantially uniform thickness that has been formed (e.g., bent such as by stamping) to form a leading closed or open tubular bulge 207A along a leading (i.e., “upwind”) edge of collecting electrodes 203A. Although tubular bulge 207A is depicted in FIG. 2B as substantially closed along its length, it may instead be formed to include open portions of varying degrees. For example, as depicted in FIG. 2C, cylindrical bulge 207B might only subtend 270 degrees or less so that the cylindrical outer surface is present facing air moving in the dominant airflow direction but is open toward the rear.

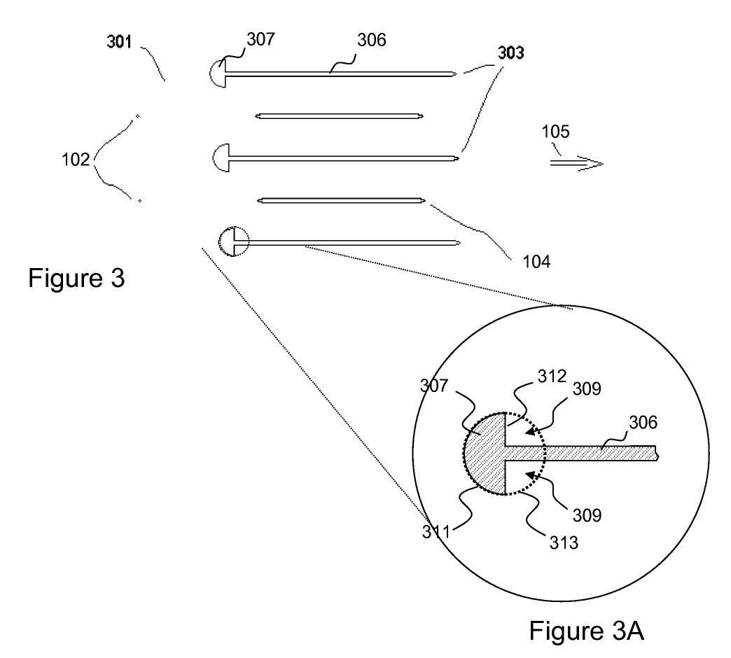

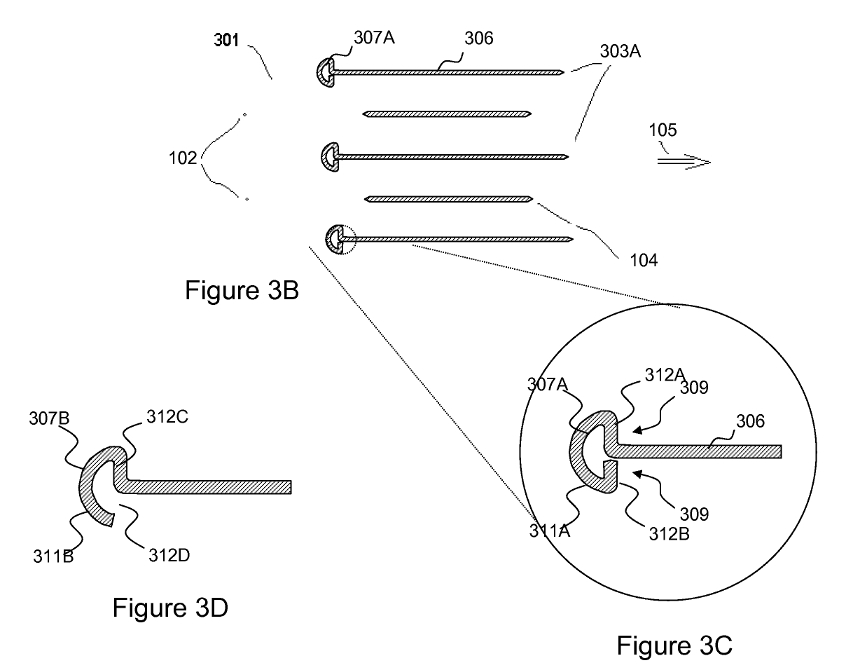

Further improvements may be obtained by implementing different shapes of the collecting electrode such as the semi-cylindrical geometry shown in the FIGS. 3 and 3A. As depicted therein, collecting electrodes 303 have a semi-cylindrical bulge 307 formed on a leading edge of the electrode, the remaining, downwind portion comprising a substantially planar or plate-like portion 306. Semi-cylindrical bulge 307 includes a curved leading edge 311 and a flat downwind edge 312 that joins planar portion 306. A nominal diameter of curved leading edge 311 would again be greater than the thickness of planar portion 311, and preferably two or three time that dimension. Although downwind edge 312 is shown as a substantially flat wall perpendicular to planar portion 306, other form factors and geometries may be used, preferably such that downwind edge 312 is within a circular region 313 defined by the extended cylinder coincident with curved leading edge 311 as shown in FIG. 3A. Downwind edge 312 should provide an abrupt transition so as to encourage turbulent flow and/or shield some portion of semi-cylindrical bulge 307 (or that of other bulge geometries, e.g., semi-elliptical) and/or section of planar portion 306 from direct and full-velocity predominant airflow to form a collecting or quiet zone. Establishment of a collecting or/or quiet zone 309 enhances collection efficiency and provide an environment conducive to dust settlement and retention.

A skeletonized version of a collecting electrode is depicted in FIGS. 3B, 3C and 3D. As shown in FIGS. 3B and 3C, collecting electrode 303A includes a leading edge 307A formed as a half-round tubular portion that is substantially closed except at the lateral edges, i.e., at the opposite far ends of the tube. Thus, downwind walls 312A and 312B are substantially complete.

An alternate configuration is depicted in FIG. 3D wherein leading edge 307B is formed as an open, i.e., instead of a wall, a open slit or aperture 312D runs the width of the electrode, only downwind wall 312C being present.

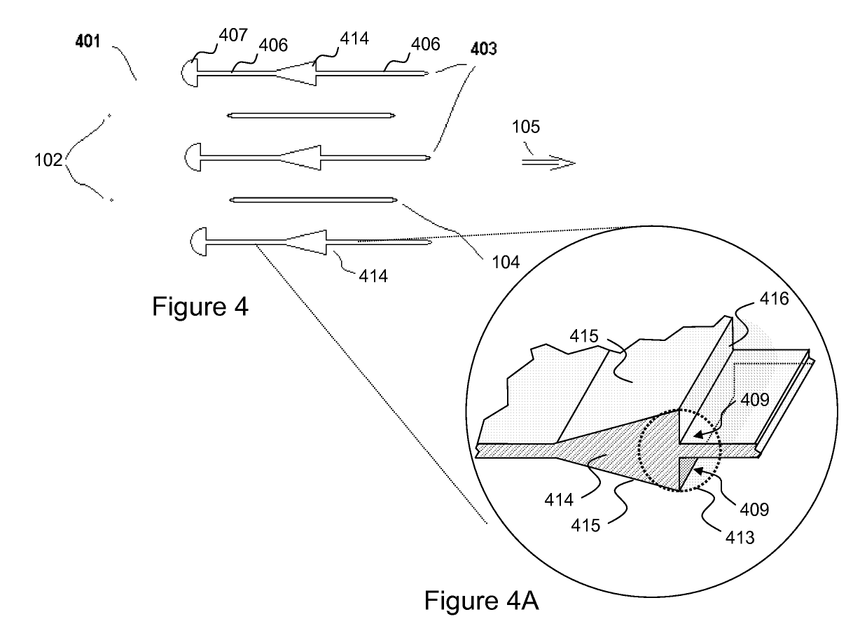

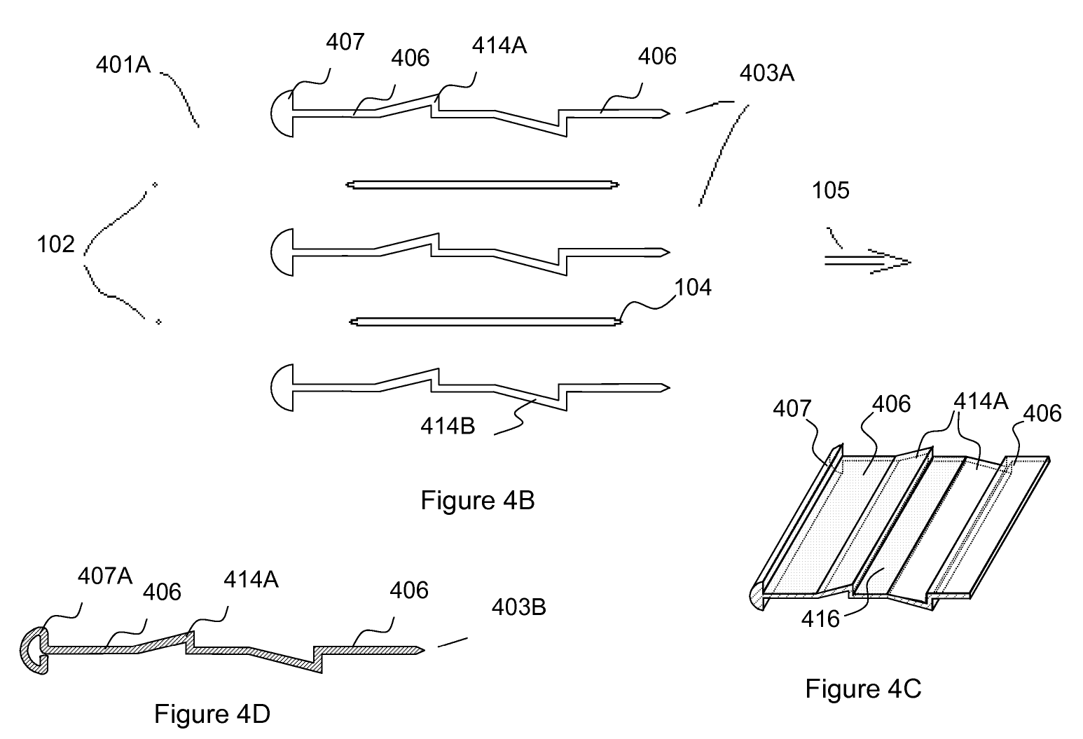

Another embodiment of the invention is depicted in FIGS. 4 and 4A wherein, in addition to bulges 407 (in this case, semi-cylindrical solid in shape) formed along the leading edge of collecting electrode 403, additional “dust traps” 414 are formed downwind of the leading edge of collecting electrode 403 creating additional quite zones. The additional quiet zones 409 formed by dust traps 414 further improve a particulate removal efficiency of the collecting electrodes and that of the overall device. As depicted, dust traps 414 may be symmetrical wedge portions having ramp portions 415 positioned on opposite surfaces of collecting electrodes 403 in an area otherwise constituting a planar portion of the electrode. Opposing ramp portions 415 rise outwardly from a planar portion of the electrode, ramp portions 415 terminating at walls 416. The slope of ramp portions 415 may be on the order of 1:1 (i.e., 45°), more preferably having a rise of no greater than 1:2 (i.e., 25°-30°) and, even more preferably greater than 1:3 (i.e., <15° to 20°). Ramp portions 415 may extend to an elevation of at least one electrode thickness in height above planar portion 406, more preferably to a height at least two electrode thicknesses, although even greater heights may be appropriate (e.g., rising to a height at least three times that of a collecting electrode thickness). Thus, if planar portion 406 is 1 mm thick, then dust traps 414 may rise 1, 2, 3 or more millimeters.

Quite zone 409 is formed in a region downwind or behind walls 416 by the redirection of airflow caused by dust trap 414 as air is relatively gently redirected along ramp portions 415. At the relatively abrupt transition of walls 416, a region of turbulent airflow is created. To affect turbulent airflow, walls 416 may be formed with a concave geometry within region 413.

While dust traps 414 are shown as a symmetrical wedge with opposing ramps located on either side of collecting electrodes 403, an asymmetrical construction may be implemented with a ramped portion located on only one surface. In addition, while only one dust trap is shown for ease of illustration, multiple dust traps may be incorporated including dust traps on alternating surfaces of each collecting electrode. Further, although the dust traps as shown shaped as wedges, other configuration may be used including, for example, semi-cylindrical geometries similar to that shown for leading edge bulges 407.

Dust traps may also be created by forming a uniform-thickness plate into a desired shape instead using a planar substrate having various structures formed thereon resulting in variations of a thickness of an electrode. For example, as shown in FIGS. 4B and 4C, collecting electrodes 403A may comprise an initial semi-cylindrical bulge 407 formed as a semi-cylindrical solid on the leading edge of a plate, the plate being bent or otherwise formed to include planar portions 406 and dust traps 414A. Note that dust traps 414A comprise a metal plate that is the same thickness as the other, adjacent portions of the electrode, i.e., planar portions 406. The dust traps may be formed by any number of processes such as by stamping, etc.

A fully skeletonized version of a collecting electrode 403B is depicted in FIG. 4D wherein bulge 407A is formed as a half-round tube having it curved outer surface facing upwind, while the flat wall-like section is oriented facing in a downwind direction.

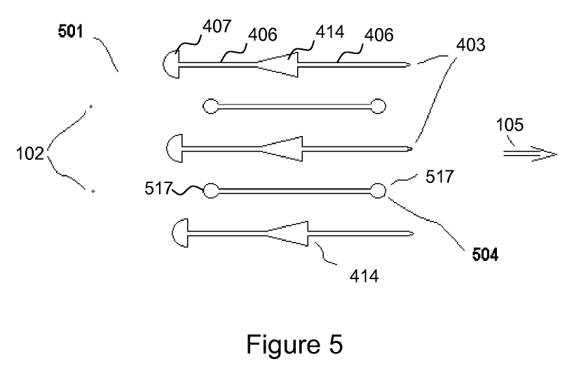

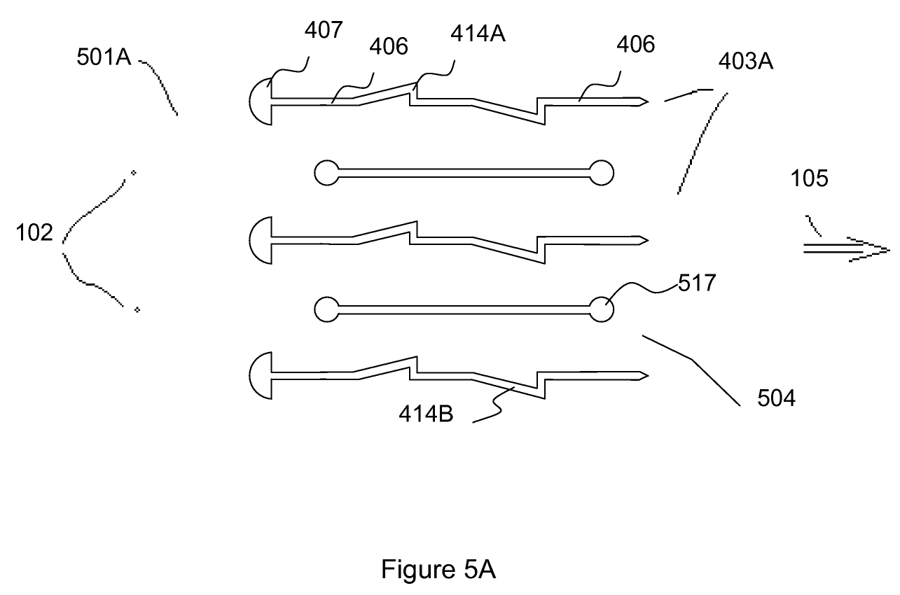

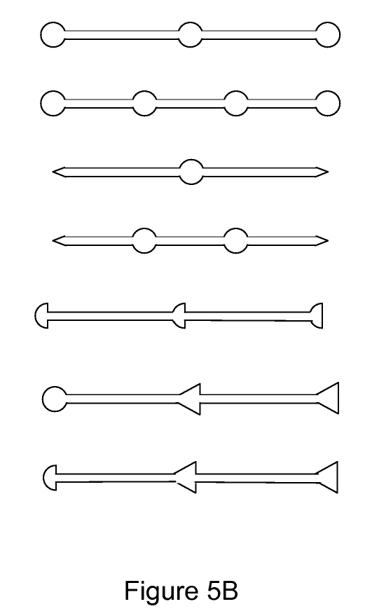

Further improvements may be achieved by developing the surfaces of repelling electrodes 504 to cooperate with collecting electrodes 403 as depicted in FIGS. 5 and 5A. Referring to FIG. 5, bulges 517 (two are shown, one each on the leading and trailing edges of repelling electrodes 504) create additional air turbulence around the repelling electrodes. Although two bulges 517 are depicted, other numbers and placement may be used. In the present example, bulges 517 are located on either side (i.e., “upwind” and “downwind”) of dust traps 414 of adjacent collecting electrodes 403. Internal to electrode array 501, repelling electrodes 504 are parallel to and flank either side of collecting electrodes 403.

Bulges 507 serve two purposes. The bulges both create additional air turbulence and increase the electric field strength in the areas between bulges 414 of collecting electrodes 403. That increased electric field “pushes” charged particles toward the collecting electrodes 403 and increases the probability that particulates present in the air (e.g., dust) will settle and remain on the surfaces of collecting electrodes 403.

FIG. 5A depicts a variation of the structure of FIG. 5 wherein a partially skeletonized form of collecting electrode 403A as depicted in and discussed with reference to FIGS. 4B and 4C is substituted for the collecting electrode structure of FIG. 4A.

Some examples of other possible repelling electrodes structures are depicted in FIG. 5B including embodiments with protuberances located on the leading and/or trailing edges of the electrodes and/or at one or more mid-section locations. Also shown are examples of possible cross-section shapes including cylindrical and ramped structures.

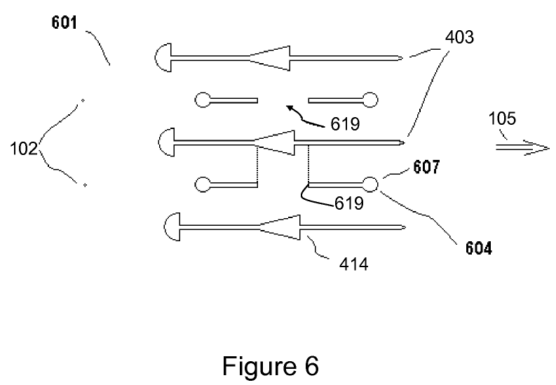

Another configuration of repelling electrode is shown in FIG. 6. Therein, repelling electrodes 604 have voids or apertures 619 (i.e., “breaks”) through the body of the electrode, the voids preferably aligned and coincident with bulges 414 of collecting electrodes 403. Thus, apertures 619 are aligned with bulges 414 such that an opening in the repelling electrode starts at or slightly after (i.e., downwind of) an initial upwind portion of an adjacent bulge (in, for example, a collecting electrode), the aperture terminating at a position at or slightly after a terminal downwind portion or edge of the bulge. Note that, although apertures 619 are depicted with a particular geometry for purposes of illustration, the aperture may be made with various modification including a wide range of holes and slots.

Apertures 619 further encourage turbulent airflow and otherwise enhance particulate removal. At the same time, this configuration avoids generation of an excessive electric field increase that might otherwise be caused by the proximity of the sharp edges of the bulges 414 to the repelling electrodes 604.

It should be noted that round or cylindrical shaped bulges 517 and 607 are located at the far upstream (leading edge) and downstream (trailing edge) ends of the repelling electrodes 504 and 604 respectively. This configuration reduces the probability of occurrence of an electrical breakdown between the edges of the repelling electrodes and the collecting electrodes, particularly in comparison with locating such bulges near a middle of the electrodes. Experimental data has shown that the potential difference between the repelling and collecting electrodes is a significant factor in maximizing device dust collection efficiency. The present configuration supports this requirement for maintaining a maximum potential difference between these groups of electrodes without fostering an electrical breakdown of the intervening fluid, e.g., arcing and/or sparking through the air.

It should also be noted that, in the embodiment of FIG. 6, the downstream or trailing edges of repelling electrodes 604 are inside that of collecting electrodes 403, i.e., the outlet edges are located closer to the inlet than the outlet edges of the collecting electrodes. This relationship further enhances a dust collecting ability while decreasing or minimizing a flow of ions out through the outlet or exhaust of the array and the device.

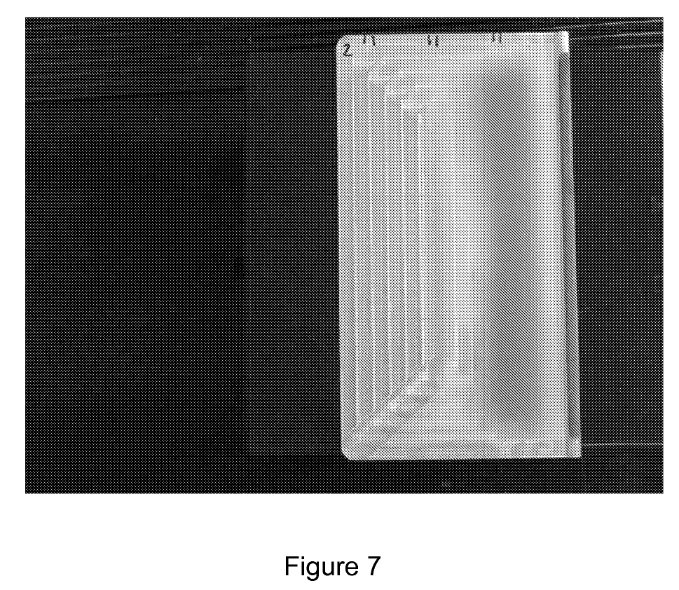

FIG. 7 is a photograph of a collecting electrode structure corresponding to FIG. 2 wherein multiple layers of conductive material are layered to produce a rounded leading edge structure.

Although certain embodiments of the present invention have been described with reference to the drawings, other embodiments and variations thereof fall within the scope of the invention. In addition, other modifications and improvements may be made and other features may be combined within the present disclosure. For example, the structures and methods detailed in U.S. patent application Ser. No. xxx,xxx (attorney docket number 432.008/10101579) filed Dec. 2, 2003 and entitled Corona Discharge Electrode And Method Of Operating The Same describes a construction of corona electrodes and method of and apparatus for rejuvenating the corona electrodes that may be combined within the spirit and scope of the present invention to provide further enhancements and features.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. It is intended by the following claims to claim any and all modifications and variations that fall within the true scope of the inventive concepts.

It should be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

What is claimed:

1. A method of operating an electrostatic fluid accelerating device comprising:
applying a voltage to a plurality of corona electrodes and a plurality of complementary electrodes so as to generate a corona discharge to thereby propel an intervening fluid in a desired fluid flow direction;
altering a direction of the fluid in a region adjacent a protuberant portion of each of said complementary electrodes to create a turbulent fluid flow in said regions adjacent said protuberant portions; and
propelling said fluid flow away from repelling electrodes and toward said complementary electrodes, each of said repelling electrodes having a substantially planar portion and at least one protuberant portion extending outwardly in a lateral direction substantially perpendicular to said desired fluid-flow direction.

2. The method according to claim 1 wherein said planar and protuberant portions of said complementary and repelling electrodes are substantially coextensive with a width of respective ones of said complementary and repelling electrodes.

3. The method according to claim 1 wherein said protuberant portions of said complementary and repelling electrodes each comprise a portion having a greater thickness than a thickness of a respective planar portion of said complementary and repelling electrodes.

4. The method according to claim 1 wherein each of said protuberant portions of said complementary and repelling electrodes comprises a portion having a thickness substantially equal to a thickness of said planar portion of said complementary and repelling electrodes.

5. The method according to claim 1 wherein each of said protuberant portions of said complementary and repelling electrodes extends in a lateral direction a distance greater than a thickness of a respective one of said planar portions of said complementary and repelling electrodes.

6. The method according to claim 1 wherein each of said protuberant portions of said complementary and repelling electrodes includes a frontal section promoting a substantially laminar fluid-flow in said fluid-flow direction and a rear section promoting a substantially turbulent fluid-flow.

7. The method according to claim 1 wherein said protuberant portion of said complementary electrodes is arranged to promote precipitation of a particulate from a fluid onto said complementary electrodes.

8. The method according to claim 1 further comprising a step of reducing a speed of the fluid in said region adjacent said protuberant portions of said complementary and repelling electrodes.

9. The method according to claim 1 wherein said protuberant portions of said complementary and repelling electrodes are each formed as a cylindrical solid.

10. The method according to claim 1 wherein said protuberant portion of said complementary electrodes are formed as a half-cylindrical solid having a curved surface facing outward from said collecting electrode and a substantially flat, walled surface attached to said planar portion of said complementary electrode.

11. The method according to claim 1 wherein said portions of said complementary and repelling electrodes are each formed as a cylindrical tube.

12. The method according to claim 1 wherein said protuberant portions of said complementary electrodes are formed as half-round tubes each having a curved surface facing outward from a respective one of said complementary electrodes.

13. The method according to claim 1 further comprising positioning said complementary electrodes substantially parallel to one another and spaced apart from one another along said lateral direction, and spacing said complementary electrodes apart from said corona electrodes in a longitudinal direction substantially parallel to a desired fluid-flow direction.

14. The method according to claim 1 wherein said protuberant portions of said complementary and repelling electrodes extend outward from a respective planes including said planar portion portions of said complementary and repelling electrodes for a distance that is at least equal to a thickness of respective ones of said planar portions.

15. The method according to claim 1, said complementary electrodes each having a trap portion spaced apart from said protuberant portions of said complementary electrodes by at least a portion of a planar portion of said complementary electrode, said trap portion extending outwardly in said lateral direction.

16. A method of operating an electrostatic air cleaning device comprising:
applying a high voltage to (i) a plurality of corona and (ii) collecting electrodes, said corona electrodes each having respective ionizing edges and said collecting electrode each having a substantially planar portion and a raised trap portion formed on a midsection of said collecting electrode and extending outwardly above a height of said substantially planar portion for a distance greater than a nominal thickness of said planar portion; and
positioning a repelling electrode intermediate adjacent pairs of said collecting electrodes.

17. The method according to claim 16 wherein each of said collecting electrodes includes a raised leading portion formed on a leading edge of each of said collecting electrodes.
